(19) United States
(12) Patent Application Publication
(10) Pub. No.: US 2021/0333110 A1
(43) Pub. Date: Oct. 28, 2021

(54) A POSITIONING SYSTEM

(71) Applicant: YILDIZ TEKNIK UNIVERSITESI, Avcilar/Istanbul (TR)

(72) Inventors: Ferkan YILMAZ, Istanbul (TR); Yeliz HATIP, Avcilar/Istanbul (TR)

(73) Assignee: YILDIZ TEKNIK UNIVERSITESI, Esenler/Istanbul (TR)

(21) Appl. No.: 17/284,143

(22) PCT Filed: Jul. 27, 2020
(86) PCT No.: PCT/TR2020/050661

§ 371 Date: Apr. 9, 2021

(30) Foreign Application Priority Data
Jul. 29, 2019 (TR) 2019/11424

(51) Int. Cl. G01C 21/30; G01P 3/00; G01C 5/00

(52) U.S. Cl. CPC G01C 21/30; G01C 5/00; G01P 3/00

(57) ABSTRACT

The present invention is a positioning system (10) for providing estimation of the global position of the vehicle where said system is provided on. The subject matter positioning system (10) comprises a memory unit (18) which keeps a height-based route map (181) including the vehicle routes and the height values provided at pluralities of points where the positions along said vehicle routes are determined, a pressure sensor (16) for realizing pressure measurement (22), a processor unit (14) embodied to take the pressure measurements (22) realized by said pressure sensor (16) and to access said memory unit (18), and a speed-meter (17) which measures the instantaneous speed of the vehicle and which transfers the instantaneous speed measurements to said processor unit (14); the processor unit (14) is configured to realize the following steps: sampling the pressure measurements (22) and the instantaneous speed measurements along a first distance (30), determining the sub-distances (31) between sampled sequential pressure measurements (22) according to the sampled instantaneous speed measurement, forming a pressure-based route pattern (20) comprising the sub-distances (31) between the sequential pressure measurements (22) and the pressure measurements (22) sampled along said first distance (30), detecting at least one which matches with the pressure-based route pattern (20) from the height-based route patterns (182) formed by said points in the height-based route map and by the height values which exist at the points and selecting at least one first point provided on the detected height-based route pattern (182).

### TECHNICAL FIELD

The present invention relates to a position estimation system for providing estimation of the global position of the vehicle where said system is provided on.

### PRIOR ART

Physical positions of vehicles bear critical importance in individual, special and military usages. The present positioning systems are mostly based on Global Positioning Satellite System (GNSS/GPS). However, GPS may be subjected to interference, or in some regions, it may become deactivated. In such cases, a solution is needed for determining the vehicle position in a correct manner.

### BRIEF DESCRIPTION OF THE INVENTION

The present invention relates to a positioning system and method, for eliminating the above mentioned disadvantages and for bringing new advantages to the related technical field.

An object of the present invention is to provide a positioning system and method which provides estimation of the position of the vehicle where GPS does not work or is not used or cannot be used.

Another object of the present invention is to provide a positioning system and method which is not affected by interference.

In order to realize the abovementioned objects and the objects which are to be deducted from the detailed description below, the present invention is a positioning system for providing estimation of the global position of the vehicle where said system is provided on. Accordingly, the improvement is that the subject matter positioning system comprises a memory unit which keeps a height-based route map including the vehicle routes and the height values provided at pluralities of points where the positions along said vehicle routes are determined, a pressure sensor for realizing pressure measurement, a processor unit embodied to take the pressure measurements realized by said pressure sensor and to access said memory unit, and a speed-meter which measures the instantaneous speed of the vehicle and which transfers the instantaneous speed measurements to said processor unit; the processor unit is configured to realize the following steps:
sampling the pressure measurements and the instantaneous speed measurements along a first distance,
determining the sub-distances between sampled sequential pressure measurements according to the sampled instantaneous speed measurement,
forming a pressure-based route pattern comprising the sub-distances between the sequential pressure measurements and the pressure measurements sampled along said first distance,
detecting at least one which matches with the pressure-based route pattern from the height-based route patterns formed by said points in the height-based route map and by the height values which exist at the points and selecting at least one first point provided on the detected height-based route pattern. Thus, the position of the vehicle is estimated by using instantaneous pressure measurements in cases where the positioning systems like GPS do not work.

In a preferred embodiment of the present invention, in the step “detecting at least one which matches with the pressure-based route pattern from the height-based route patterns formed by said points in the height-based route map and by the height values which exist at the points and selecting at least one first point provided on the detected height-based route pattern”, said first point is the point which matches with the last taken pressure measurement sample which exists in the pressure-based route pattern.

In another preferred embodiment of the present invention, the processor unit is configured to make search among the height-based route patterns between a target point and a departure point while detecting matching in the step “detecting at least one which matches with the pressure-based route pattern from the height-based route patterns formed by said points in the height-based route map and by the height values which exist at the points and selecting at least one first point provided on the detected height-based route pattern”. Thus, accelerated position estimation is realized.

In another preferred embodiment of the present invention, the processor unit is configured to provide showing the selected first point on a map which exists on a screen.

The present invention is moreover a positioning method for providing estimation of the global position of the vehicle where said system is provided on. Accordingly, the improvement is that the following steps are realized by a processor unit:
taking pressure measurements from a pressure sensor positioned in said vehicle and which realizes pressure measurements,
taking speed measurements from a speed-meter which measures the instantaneous speed of the vehicle,
sampling the instantaneous speed measurements and pressure measurements along a first distance,
determining the sub-distances between sampled sequential pressure measurements in accordance with the sampled instantaneous speed measurement,
forming a pressure-based route pattern comprising the sub-distances between the pressure measurements, sampled along said first distance, and the sequential pressure measurements,
accessing a memory unit which keeps a height-based route map comprising vehicle routes and height values at multiple points where the positions along said vehicle routes are determined,
detecting at least one which matches with the pressure-based route pattern from the height-based route patterns formed by said points in the height-based route map and by the height values which exist at the points and selecting at least one first point provided on the detected height-based route pattern.

In another preferred embodiment of the present invention, in the step of “detecting at least one which matches with the pressure-based route pattern from the height-based route patterns formed by said points in the height-based route map and by the height values which exist at the points and selecting at least one first point provided on the detected height-based route pattern”, said first point is a point which matches with the finally taken pressure measurement sample which exists in the pressure-based route pattern.

In another preferred embodiment of the present invention, in the step of “detecting at least one which matches with the pressure-based route pattern from the height-based route patterns formed by said points in the height-based route map and by the height values which exist at the points and selecting at least one first point provided on the detected height-based route pattern”, the processor unit searches among the height-based route patterns between a departure point and a target point while detecting the match.

### BRIEF DESCRIPTION OF THE FIGURES

FIG. 1 is a schematic view of the positioning system.

FIG. 2 is a representative view of the height-based route map and height-based route pattern.

FIG. 3 is a representative view of the pressure-based route pattern.

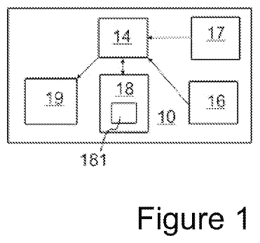

### DETAILED DESCRIPTION OF THE INVENTION

In this detailed description, the subject matter is explained with references to examples without forming any restrictive effect only in order to make the subject more understandable.

The present invention relates to a positioning system (10) for providing estimation of the present position in an offline manner in case GPS system cannot be accessed in vehicles.

Accordingly, the positioning system (10) comprises a memory unit (18) which keeps a height-based route map (181) comprising the possible vehicle routes and the height values at pluralities of points where the distances in between along said vehicle routes are known. Said memory unit (18) comprises a permanent memory which at least provides the data to be kept in a permanent manner, and a temporary memory which preferably comprises keeping the data in a temporary manner. The positioning system (10) also comprises a processor unit (14) configured to access the memory unit (18). Said processor (14) can be a microprocessor.

The height information of the vehicle routes can be taken from a digital topographical database comprising height information on the earth surface. For instance, the search of “Shuttle Radar Topography Mission” obtains such data.

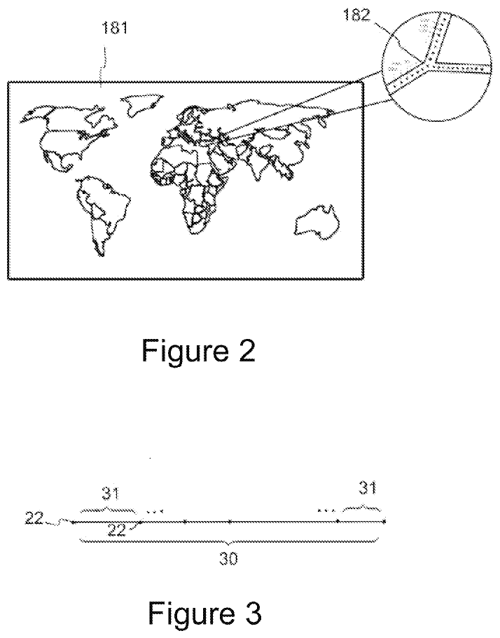

With reference to FIG. 2, the height-based route map (181) has been given in a representative form. In the height-based route map (181), there are the points of which the position is known and there are the heights of these points. The view in FIG. 2 is representative and the height-based route map (181) can be described also in the form of arrays and matrices which comprise the coordinates and heights of the points. A part of the height-based route map (181), formed by these points and formed by the height values of these points, is defined as the height-based route pattern (182).

The positioning system (10) comprises a pressure sensor (16) which measures the instantaneous open air pressure in the medium and which transfers the pressure measurements to the processor unit (14). The positioning system (10) moreover comprises a speed-meter (17) which measures the speed of the vehicle. The speed-meter (17) can send a signal to the processor unit (14) in a manner describing the speed and movement direction of the vehicle. In an exemplary embodiment, the processor unit (14) only takes data related to the speed of the vehicle from the speed-meter (17), and the processor unit (14) can determine the movement direction of the vehicle by means of measurement devices associated with the other equipment of the vehicle.

The positioning system functions in this manner: The processor unit (14) samples the pressure measurements (22) along a first distance (30) and the speed measurements at the time when these pressure measurements (22) are taken. The speed measurements are in vector type. The processor unit (14) determines the sub-distances between the sequential pressure measurements (22) in accordance with the speed measurements at the points where the pressure measurements (22) are taken. The processor unit (14) forms pressure measurements (22) along a first distance (30) and a pressure-based route pattern (20) comprising the sub-distances (31) between the pressure measurements (22). The pressure-based route pattern (20) has been illustrated in FIG. 3 in a representative form.

The processor unit (14) accesses the height-based route map (181) in the memory unit (18). Afterwards, the processor unit (14) searches the height-based route patterns (182) which are similar to the formed pressure-based route pattern (20) or which match with the pressure-based route pattern (20) in the height-based route map (181). When it finds a matching or a similar height-based route pattern (182), the point of the found height-based route pattern (182) which corresponds to or which matches with the final taken pressure measurement (22) is selected, and thus, the position of the vehicle is estimated.

During the height-based route pattern (182) search which is compliant to or which matches with the formed pressure-based route pattern (20), first of all, the height is estimated from the measured pressure. This scans the height-based route patterns (182) which are the closest to the estimated height or which comprise the estimated height.

In a possible embodiment, the processor unit (14) scans the height-based route patterns (182) which exist at routes between a target point and a pre-selected departure point during height-based route pattern (182) search which is compliant to or which matches with the formed pressure-based route pattern (20).

As height increases, the pressure decreases and as height decreases, the pressure increases. The pressure measurements (22) show change in accordance with the height of the route in accordance with this rationale. During the height-based route pattern (182) search which is compliant to or which matches with the formed pressure-based route pattern (20), process is realized by taking into account this rationale.

The height information of the vehicle routes can be provided by means of realizing pressure measurement (22) by a vehicle, which makes pressure measurement (22), in all possible routes besides height data obtained by means of “Shuttle Radar Topography Mission” search. By means of these measurements and by means of the positions of the points where measurements are taken, a height-based route map (181) can be formed.

The protection scope of the present invention is set forth in the annexed claims and cannot be restricted to the illustrative disclosures given above, under the detailed description. It is because a person skilled in the relevant art can obviously produce similar embodiments under the light of the foregoing disclosures, without departing from the main principles of the present invention.

### REFERENCE NUMBERS

10 Positioning system

14 Processor unit

16 Pressure sensor

17 Speed-meter

18 Memory unit

181 Height-based route map

182 Height-based route pattern

19 Screen

20 Pressure-based route pattern

22 Pressure measurements

30 First distance

31 Sub-distance

1. A positioning system for estimation of the global position of a vehicle where said system is provided on, wherein the positioning system comprises a memory unit which keeps a height-based route map including a route of the vehicle and the height values provided at a plurality of points along the route, a pressure sensor for realizing pressure measurement, a processor unit embodied to take the pressure measurements realized by said pressure sensor and to access said memory unit, and a speedometer which measures the instantaneous speed of the vehicle and which transfers the instantaneous speed measurements to said processor unit;
wherein the processor unit is configured for:
sampling the pressure measurements and the instantaneous speed measurements along a first distance;
determining a sub-distance between sampled sequential pressure measurements according to the sampled instantaneous speed measurement
forming a pressure-based route pattern comprising the sub-distance between the sequential pressure measurements and the pressure measurements sampled along said first distance; and
detecting vehicle route pattern which matches with the pressure-based route pattern from the height-based route patterns formed by said points in the height-based route map and by the height values which exist at the points and selecting a first point provided on the detected height-based route pattern.

2. The positioning system according to claim 1, wherein said first point is the point which matches with the last taken pressure measurement sample which exists in the pressure-based route pattern.

3. The positioning system according to claim 1, wherein the processor unit is configured to search among the height-based route patterns between a target point and a departure point while detecting a matching pressure measurement.

4. The positioning system according to claim 1, wherein the processor unit is configured to display the selected first point on a map which exists on a screen.

5. A positioning method for estimation of the global position of a vehicle, the method comprising:
taking pressure measurements from a pressure positioned in said vehicle;
taking speed measurements from a speedometer which measures the instantaneous speed of the vehicle;
sampling the speed measurements and pressure measurements along a first distance;
determining a sub-distance between the sampled sequential pressure measurements in accordance with the sampled instantaneous speed measurement;
forming a pressure-based route pattern comprising the sub-distance between the pressure measurements, sampled along said first distance, and the sequential pressure measurements;
accessing a memory unit which keeps a height-based route map comprising a plurality of vehicle routes and height values at multiple points along said vehicle routes; and
detecting a vehicle route which matches with the pressure-based route pattern from the height-based route patterns formed by said points in the height-based route map and by the height values which exist at the points and selecting a first point provided on the detected height-based route pattern.

6. The positioning system according to claim 1, wherein said first point is a point which matches with the finally taken pressure measurement sample which exists in the pressure-based route pattern.

7. The positioning system according to claim 1, wherein detecting a vehicle route comprises searching among the height-based route patterns between a departure point and a target point while detecting the match.
